(19) United States
(12) Patent Application Publication
(10) Pub. No.: US 2024/0340738 A1
(43) Pub. Date: Oct. 10, 2024

(54) METHOD FOR CONTROLLING SELECTIVE ADMISSION DURING MIGRATION BETWEEN DONORS IN BACKHAUL AND ACCESS HOLE COMBINATION SYSTEM

(71) Applicant: Samsung Electronics Co., Ltd., Suwon-si, Gyeonggi-do (KR)

(72) Inventor: June HWANG, Suwon-si (KR)

(21) Appl. No.: 18/577,069

(22) PCT Filed: Jul. 13, 2022
(86) PCT No.: PCT/KR2022/010210

§ 371 Date: Jan. 5, 2024

(30) Foreign Application Priority Data
Jul. 15, 2021 (KR) 10-2021-0093115

(51) Int. Cl. H04W 36/08; H04W 36/00; H04W 76/20; H04W 88/08

(52) U.S. Cl. CPC H04W 36/087; H04W 36/0061; H04W 76/20; H04W 88/08

(57) ABSTRACT

The disclosure relates to a 5G or pre-5G communication system for supporting a data transmission rate higher than that of a 4G communication system, such as long term evolution (LTE). The present disclosure relates to a method for controlling signal processing in a wireless communication system, and the method may comprise the steps of: receiving a first control signal transmitted from a base station; processing the received first control signal; and transmitting, to the base station, a second control signal generated on the basis of the processing.

### TECHNICAL FIELD

The disclosure relates to an apparatus and method for controlling admission during migration between integrated access and backhaul (IAB) donors in a communication system.

### BACKGROUND ART

To satisfy the increasing demand for radio data traffic after the commercialization of 4G communication systems, efforts have been made to develop improved 5G or pre-5G communication systems. As such, 5G or pre-5G communication systems are also called “beyond 4G network” or “post LTE system”. To achieve higher data rates, 5G communication systems are being considered for implementation in the extremely high frequency (mmWave) band (e.g., 60 GHz band). To decrease path loss of radio waves and increase the transmission distance in the mmWave band, various technologies including beamforming, massive multiple-input multiple-output (massive MIMO), full dimensional MIMO (FD-MIMO), array antennas, analog beamforming, and large scale antennas are considered for 5G communication systems. Additionally, to improve system networks in 5G communication systems, technology development is under way regarding evolved small cells, advanced small cells, cloud radio access networks (cloud RANs), ultra-dense networks, device-to-device (D2D) communication, wireless backhaul, moving networks, cooperative communication, coordinated multi-points (CoMP), interference cancellation, and the like. In addition, advanced coding and modulation (ACM) schemes such as hybrid FSK and QAM modulation (FQAM) and sliding window superposition coding (SWSC), and advanced access technologies such as filter bank multi carrier (FBMC), non-orthogonal multiple access (NOMA), and sparse code multiple access (SCMA) are also under development for 5G communication systems.

Meanwhile, the Internet is evolving from a human centered network where humans create and consume information into the Internet of Things (IoT) where distributed elements or things process and exchange information. There has also emerged the Internet of Everything (IoE) technology that combines IoT technology with big data processing technology through connection with cloud servers. To realize IoT services, base technologies related to sensing, wired/wireless communication and network infrastructure, service interfacing, and security are needed, and technologies interconnecting things such as sensor networks, machine-to-machine (M2M) or machine type communication (MTC) are under development. In IoT environments, it is possible to provide intelligent Internet technology services, which collect and analyze data created by interconnected things to add new values to human life. Through convergence and combination between existing information technologies and various field technologies, IoT technology may be applied to various areas such as smart homes, smart buildings, smart cities, smart or connected cars, smart grids, health-care, smart consumer electronics, and advanced medical care.

Accordingly, various attempts are being made to apply 5G communication systems to IoT networks. For example, sensor networks and machine-to-machine or machine type communication are being realized by use of 5G communication technologies including beamforming, MIMO, and array antennas. Application of cloud RANs as a big data processing technique described above may be an instance of convergence of 5G technology and IoT technology.

As described above, as various services can be provided according to the development of wireless communication systems, a method for effectively providing these services is required.

### DISCLOSURE OF INVENTION

### Technical Problem

During inter donor migration of an IAB node, not only the migrating IAB node but also its descendant nodes and their access UEs may be migrated to the target donor node. Accordingly, instead of an existing scheme where admission control for handover is performed for each UE, a method of admission control for multiple descendant nodes and their access UEs is needed.

### Solution to Problem

According to an embodiment of the disclosure, there is provided a method performed by a source base station including a central unit (CU) and a distributed unit (DU) in a wireless communication system supporting integrated access and backhaul (IAB). The method may include: transmitting, to a target base station, a handover request message including an indication indicating migration of at least one IAB node; and receiving, from the target base station, a handover request response message including configuration information according to the result of admission control based on the indication.

According to an embodiment of the disclosure, there is provided a method performed by a target base station including a central unit (CU) and a distributed unit (DU) in a wireless communication system supporting integrated access and backhaul (IAB). The method may include: receiving, from a CU of a source base station, a handover request message including an indication indicating migration of at least one IAB node; performing admission control based on the handover request message; and transmitting a handover request response message including configuration information according to the result of admission control.

According to an embodiment of the disclosure, there is provided a source base station including a central unit (CU) and a distributed unit (DU) in a wireless communication system supporting integrated access and backhaul (IAB), wherein the CU may be configured to transmit, to a target base station, a handover request message including an indication indicating migration of at least one IAB node, and receive, from the target base station, a handover request response message including configuration information according to the result of admission control based on the indication.

According to an embodiment of the disclosure, there is provided a target base station including a central unit (CU) and a distributed unit (DU) in a wireless communication system supporting integrated access and backhaul (IAB), wherein the CU may be configured to receive, from a CU of a source base station, a handover request message including an indication indicating migration of at least one IAB node, perform admission control based on the handover request message, and transmit a handover request response message including configuration information according to the result of admission control.

To solve the above problems, in the disclosure, configuration information needed to perform migration is provided in advance to descendant nodes of a migrating IAB node and access UEs in a communication system and the configuration information is applied when a specific condition is met. This configuration information may contain information that controls the mobility of the descendant nodes and their access UEs. Through this, admission control can be selectively performed during migration of descendant nodes and their access UEs.

### Advantageous Effects of Invention

In an apparatus and method according to embodiments of the disclosure, the communication delay time of the access UE (terminal) after performing migration can be removed by eliminating the delay time for the descendant nodes and their access UEs to request and obtain configuration information of the IAB node.

### BRIEF DESCRIPTION OF DRAWINGS

FIG. 1 is a diagram illustrating the architecture of an LTE system according to an embodiment of the disclosure.

FIG. 2 is a diagram illustrating the structure of radio protocols in an LTE system according to an embodiment of the disclosure.

FIG. 3 is a diagram illustrating the architecture of a next-generation mobile communication system according to an embodiment of the disclosure.

FIG. 4 is a diagram illustrating the structure of radio protocols in a next-generation mobile communication system according to an embodiment of the disclosure.

FIG. 5 is a block diagram showing the structure of a UE according to an embodiment of the disclosure.

FIG. 6 is a block diagram showing the structure of an NR base station according to an embodiment of the disclosure.

FIG. 7A illustrates a network structure according to an embodiment of the disclosure.

FIG. 7B illustrates signal flows when admission control is performed collectively in migration according to an embodiment of the disclosure.

FIG. 7B illustrates signal flows when admission control is performed collectively in migration according to an embodiment of the disclosure.

### MODE FOR THE INVENTION

Hereinafter, the operating principle of the disclosure will be described in detail with reference to the accompanying drawings. In describing the disclosure, descriptions of functions and structures well known in the art may be omitted for clarity and conciseness without obscuring the subject matter of the disclosure. Also, the terms described below are defined in consideration of their functions in the disclosure, and these may vary depending on the intention of the user, the operator, or the custom. Hence, their meanings should be determined based on the overall contents of this specification.

Those terms used in the following description for identifying an access node, indicating a network entity, indicating a message, indicating an interface between network entities, and indicating various identification information are taken as illustration for ease of description. Accordingly, the disclosure is not limited by the terms to be described later, and other terms referring to objects having an equivalent technical meaning may be used.

For convenience of description, the disclosure uses terms and names defined in the standards for 3GPP LTE (3rd Generation Partnership Project Long Term Evolution). However, the disclosure is not limited by the above terms and names, and can be equally applied to systems conforming to other standards. In the disclosure, “eNB” may be used interchangeably with “gNB” for convenience of description. That is, a base station described as an eNB may indicate a gNB. Also, the term “terminal” may refer to a mobile phone, a NB-IoT device, a sensor, or another wireless communication device. Advantages and features of the disclosure and methods for achieving them will be apparent from the following detailed description of embodiments taken in conjunction with the accompanying drawings. However, the disclosure is not limited to the embodiments disclosed below but may be implemented in various different ways, the embodiments are provided only to complete the disclosure and to fully inform the scope of the disclosure to those skilled in the art to which the disclosure pertains, and the disclosure is defined only by the scope of the claims. The same reference symbols are used throughout the specification to refer to the same parts.

Meanwhile, it will be appreciated that blocks of a flowchart and a combination of flowcharts may be executed by computer program instructions. These computer program instructions may be loaded on a processor of a general purpose computer, special purpose computer, or programmable data processing equipment, and the instructions executed by the processor of a computer or programmable data processing equipment create a means for carrying out functions described in blocks of the flowchart. To implement the functionality in a certain way, the computer program instructions may also be stored in a computer usable or readable memory that is applicable in a specialized computer or a programmable data processing equipment, and it is possible for the computer program instructions stored in a computer usable or readable memory to produce articles of manufacture that contain a means for carrying out functions described in blocks of the flowchart. As the computer program instructions may be loaded on a computer or a programmable data processing equipment, when the computer program instructions are executed as processes having a series of operations on a computer or a programmable data processing equipment, they may provide steps for executing functions described in blocks of the flowchart.

Additionally, each block of a flowchart may correspond to a module, a segment or a code containing one or more executable instructions for executing one or more logical functions, or to a part thereof. It should also be noted that functions described by blocks may be executed in an order different from the listed order in some alternative cases. For example, two blocks listed in sequence may be executed substantially at the same time or executed in reverse order according to the corresponding functionality.

Here, the word “unit”, “module”, or the like used in the embodiments may refer to a software component or a hardware component such as an FPGA (field programmable gate array) or ASIC (application specific integrated circuit) capable of carrying out a function or an operation. However, “unit” or the like is not limited to hardware or software. A unit or the like may be configured so as to reside in an addressable storage medium or to drive one or more processors. For example, units or the like may refer to components such as a software component, object-oriented software component, class component or task component, processes, functions, attributes, procedures, subroutines, program code segments, drivers, firmware, microcode, circuits, data, databases, data structures, tables, arrays, or variables. A function provided by a component and unit may be a combination of smaller components and units, and it may be combined with others to compose larger components and units. Further, components and units may be implemented to drive one or more CPUs in a device or a secure multimedia card. Also, in an embodiment, a unit or the like may include one or more processors.

In the following description of the disclosure, detailed descriptions of well-known functions and structures incorporated herein may be omitted to avoid obscuring the subject matter of the disclosure. Hereinafter, embodiments of the disclosure will be described with reference to the accompanying drawings.

Those terms used in the following description for identifying an access node, indicating a network entity, indicating a message, indicating an interface between network entities, and indicating various identification information are taken as illustration for ease of description. Accordingly, the disclosure is not limited by the terms to be described later, and other terms referring to objects having an equivalent technical meaning may be used. For example, in the following description, the “terminal” may refer to a MAC entity within a terminal belonging to a master cell group (MCG) or a secondary cell group (SCG), which will be described later.

In the following description, the base station (BS), as a main agent that allocates resources to a terminal, may be at least one of gNode B, eNode B, Node B, radio access unit, base station controller, or node on a network. The terminal may include, but not limited to, a user equipment (UE), a mobile station (MS), a cellular phone, a smartphone, a computer, or a multimedia system capable of performing a communication function. In particular, the disclosure can be applied to 3GPP NR (5^{th} generation mobile communication standards). Also, the disclosure may be applied to, based on 5G communication technology and IoT related technology, intelligent services (e.g., smart home, smart building, smart city, smart or connected car, health care, digital education, retail, security, and safety related services). In the disclosure, “eNB” may be used interchangeably with “gNB” for convenience of description. That is, a base station described as an eNB may indicate a gNB. Also, the term “terminal” may refer to a mobile phone, a NB-IoT device, a sensor, or another wireless communication device. Wireless communication systems are evolving from early systems that provided voice-oriented services only to broadband wireless communication systems that provide high-speed and high-quality packet data services, such as systems based on communication standards including 3GPP high speed packet access (HSPA), long term evolution (LTE) or evolved universal terrestrial radio access (E-UTRA), LTE-advanced (LTE-A), LTE-Pro, 3GPP2 high rate packet data (HRPD), ultra mobile broadband (UMB), and IEEE 802.16e.

As a representative example of the broadband wireless communication system, the LTE system employs orthogonal frequency division multiplexing (OFDM) in the downlink (DL) and single carrier frequency division multiple access (SC-FDMA) in the uplink (UL). The uplink refers to a radio link through which a terminal (user equipment (UE) or mobile station (MS)) sends data or a control signal to a base station (BS or eNode B), and the downlink refers to a radio link through which a base station sends data or a control signal to a terminal. In such a multiple access scheme, time-frequency resources used to carry user data or control information are allocated so as not to overlap each other (i.e., maintain orthogonality) to thereby identify the data or control information of a specific user.

As a post-LTE communication system, namely, the 5G communication system must be able to freely reflect various requirements of users and service providers and need to support services satisfying various requirements. Services considered for the 5G communication system include enhanced mobile broadband (eMBB), massive machine type communication (mMTC), and ultra-reliable and low-latency communication (URLLC).

According to some embodiments, eMBB aims to provide a data transmission rate that is more improved in comparison to the data transmission rate supported by existing LTE, LTE-A, or LTE-Pro. For example, in the 5G communication system, eMBB must be able to provide a peak data rate of 20 Gbps in the downlink and a peak data rate of 10 Gbps in the uplink from the viewpoint of one base station. In addition, the 5G communication system may have to provide not only the peak transmission rate but also an increased user perceived data rate for the terminal. To meet such requirements in the 5G communication system, it may be required to improve the transmission and reception technology including more advanced multi-antenna or multi-input multi-output (MIMO) technology. In addition, it is possible to satisfy the data transmission rate required by the 5G communication system by using a frequency bandwidth wider than 20 MHz in a frequency band of 3 to 6 GHz or 6 GHz or higher instead of a transmission bandwidth of up to 20 MHz in a band of 2 GHz currently used by LTE.

At the same time, in the 5G communication system, mMTC is considered to support application services such as the Internet of Things (IoT). For efficient support of IoT services, mMTC is required to support access of a massive number of terminals in a cell, extend the coverage for the terminal, lengthen the battery time, and reduce the cost of the terminal. The Internet of Things must be able to support a massive number of terminals (e.g., 1,000,000 terminals/km²) in a cell to provide a communication service to sensors and components attached to various devices. In addition, since a terminal supporting mMTC is highly likely to be located in a shadow area not covered by a cell, such as the basement of a building, due to the nature of the service, it may require wider coverage compared to other services provided by the 5G communication system. A terminal supporting mMTC should be configured as a low-cost terminal, and since it is difficult to frequently replace the battery of a terminal, a very long battery life time such as 10 to 15 years may be required.

Finally, URLLC, as cellular-based mission-critical wireless communication service for a specific purpose, is a service usable for remote control of robots or machinery, industrial automation, unmanned aerial vehicles, remote health care, and emergency alert. Hence, URLLC should provide ultra-reliable and low-latency communication. For example, a URLLC service may have to support both an air interface latency of less than 0.5 ms and a packet error rate of 10⁻⁵ or less as a requirement. Hence, for a service supporting URLLC, the 5G system must provide a transmission time interval (TTI) shorter than that of other services, and at the same time, a design requirement for allocating a wide resource in a frequency band may be required.

The above three services considered in the 5G communication system (i.e., eMBB, URLLC, and mMTC) can be multiplexed and transmitted in one system. Here, to satisfy different requirements of the services, different transmission and reception techniques and parameters can be used. However, mMTC, URLLC, and eMBB described above are only an example of different service types, and the service types to which the disclosure is applied are not limited to the above-described examples.

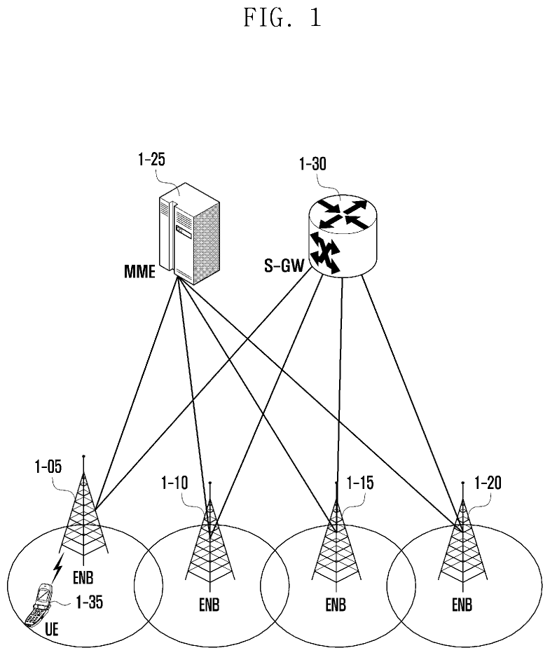

Further, embodiments of the disclosure will be described by using LTE, LTE-A, LTE Pro or 5G (NR or next generation) systems as an example, but the embodiments of the disclosure may be applied to other communication systems having similar technical backgrounds or channel configurations. Also, it should be understood by those skilled in the art that the embodiments of the disclosure can be applied to other communication systems without significant modifications departing from the scope of the disclosure. FIG. 1 is a diagram illustrating the architecture of an LTE system according to an embodiment of the disclosure.

With reference to FIG. 1, as illustrated, the radio access network of the LTE system may be composed of a next-generation base station (evolved node B, ENB, Node B or base station) 1-05, 1-10, 1-15 or 1-20, a mobility management entity (MME) 1-25, and a serving-gateway (S-GW) 1-30. A user equipment (UE or terminal) 1-35 may connect to an external network through the ENB 1-05, 1-10, 1-15 or 1-20 and the S-GW 1-30.

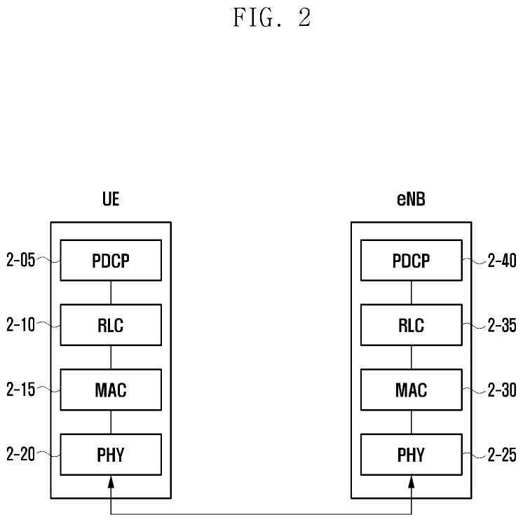

In FIG. 1, the ENBs 1-05, 1-10, 1-15 and 1-20 may correspond to existing Node Bs of the universal mobile telecommunication system (UMTS). The ENB is connected to the UE 1-35 through a radio channel, but performs more complex functions in comparison to the existing Node B. In the LTE system, all user traffic including real-time services like VoIP (Voice over IP) may be served through shared channels. Hence, an apparatus is needed to perform scheduling on the basis of collected status information regarding buffers, available transmit powers and channels of the UEs, and the ENBs 1-05, 1-10, 1-15 and 1-20 can be responsible for this. One ENB may control multiple cells in a typical situation. To achieve a data rate of, for example, 100 Mbps in a bandwidth of, for example, 20 MHz, the LTE system may utilize orthogonal frequency division multiplexing (OFDM) as radio access technology. Also, the LTE system may apply adaptive modulation and coding (AMC) to determine the modulation scheme and channel coding rate according to channel states of the UE. The S-GW 1-30 is an entity providing data bearers, and may create and remove data bearers under the control of the MME 1-25. The MME is an entity in charge of various control functions including a mobility management function for the UE, and may be connected to a plurality of ENBs. FIG. 2 is a diagram illustrating the structure of radio protocols in the LTE system according to an embodiment of the disclosure.

With reference to FIG. 2, in a UE or an ENB, the radio protocols of the LTE system may be composed of packet data convergence protocol (PDCP) 2-05 or 2-40, radio link control (RLC) 2-10 or 2-35, medium access control (MAC) 2-15 or 2-30, and physical (PHY) layer 2-20 or 2-25. However, it is not limited to the above example, and fewer or more entities or layers than the above example may be included.

According to an embodiment of the disclosure, the PDCP may perform compression and decompression of IP headers. The main functions of the PDCP may be summarized as follows in a non-limiting manner.
Header compression and decompression function (header compression and decompression: robust header compression (ROHC) only)
User data transfer function (transfer of user data)
In-sequence delivery function (in-sequence delivery of upper layer protocol data units (PDUs) at PDCP re-establishment procedure for RLC acknowledged mode (AM))
Reordering function (for split bearers in dual connectivity (DC) (only support for RLC AM): PDCP PDU routing for transmission and PDCP PDU reordering for reception)
Duplicate detection function (duplicate detection of lower layer SDUs at PDCP re-establishment procedure for RLC AM)
Retransmission function (retransmission of PDCP SDUs at handover and, for split bearers in DC, of PDCP PDUs at PDCP data-recovery procedure, for RLC AM)
Cipher and decipher function (ciphering and deciphering)
Timer-based SDU discard function (timer-based SDU discard in uplink) According to an embodiment, the radio link control (RLC) 2-10 or 2-35 may reconfigure PDCP PDUs (packet data unit) to a suitable size and perform automatic repeat request (ARQ) operation. The main functions of the RLC may be summarized as follows in a non-limiting manner.
   Data transfer function (transfer of upper layer PDUs)
ARQ function (error correction through ARQ (only for AM data transfer))
Concatenation, segmentation and reassembly function (concatenation, segmentation and reassembly of RLC SDUs (only for UM and AM data transfer))
Re-segmentation function (re-segmentation of RLC data PDUs (only for AM data transfer))
Reordering function (reordering of RLC data PDUs (only for UM and AM data transfer))
Duplicate detection function (duplicate detection (only for UM and AM data transfer))
Error detection function (protocol error detection (only for AM data transfer))
   RLC service data unit (SDU) discard function (RLC SDU discard (only for UM and AM data transfer))
RLC re-establishment function (RLC re-establishment)

According to an embodiment, the MAC 2-15 or 2-30 may be connected with multiple RLC entities in a UE, and it may multiplex RLC PDUs into MAC PDUs and demultiplex MAC PDUs into RLC PDUs. The main functions of the MAC may be summarized as follows in a non-limiting manner.
Mapping function (mapping between logical channels and transport channels)
Multiplexing and demultiplexing function (multiplexing/demultiplexing of MAC SDUs belonging to one or different logical channels into/from transport blocks (TB) delivered to/from the physical layer on transport channels)
Scheduling information reporting function (scheduling information reporting)
HARQ function (error correction through HARQ)
Priority handling function between logical channels (priority handling between logical channels of one UE)
Priority handling function between UEs (priority handling between UEs by means of dynamic scheduling)
MBMS service identification function (MBMS service identification)
Transport format selection function (transport format selection)
Padding function (padding)

According to an embodiment, the physical (PHY) layer 2-20 or 2-25 may convert higher layer data into OFDM symbols by means of channel coding and modulation and transmits the OFDM symbols through a radio channel, or it may demodulate OFDM symbols received through a radio channel, perform channel decoding, and forward the result to a higher layer. However, it is not limited to the above example.

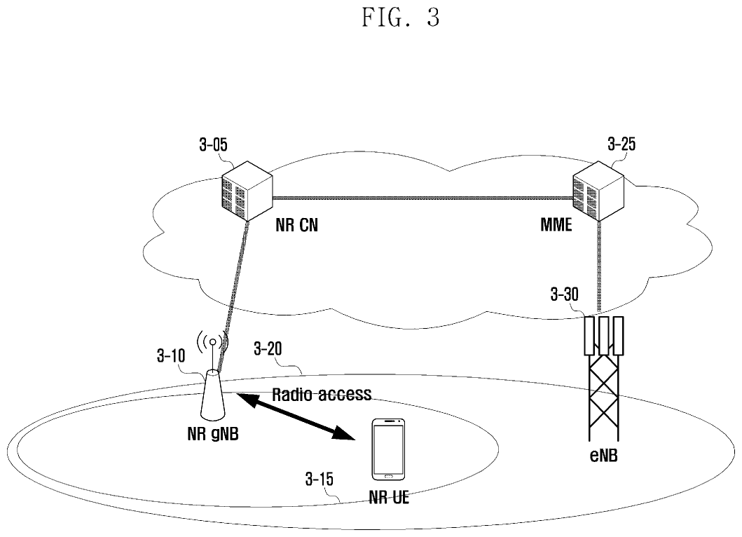

FIG. 3 is a diagram showing the architecture of a next-generation mobile communication system according to an embodiment of the disclosure.

With reference to FIG. 3, the radio access network of a next-generation mobile communication system (hereinafter, NR or 5G) may be composed of a new radio node B (hereinafter, NR gNB or NR base station) 3-10 and a new radio core network (NR CN) 3-05. A new radio user equipment (NR UE or terminal) 3-15 may connect to an external network through the NR gNB 3-10 and the NR CN 3-05.

In FIG. 3, the NR gNB 3-10 may correspond to an evolved node B (eNB) of the existing LTE system. The NR gNB 3-10 may be connected to the NR UE 3-15 through a radio channel, and it can provide a more superior service than that of the existing node B. All user traffic may be serviced through shared channels in the next-generation mobile communication system. Hence, there is a need for an entity that performs scheduling by collecting status information, such as buffer states, available transmission power states, and channel states of individual UEs, and the NR gNB 3-10 may take charge of this.

One NR gNB 3-10 may control a plurality of cells. To implement ultra-high-speed data transmission compared with current LTE, a bandwidth beyond the existing maximum bandwidth may be utilized in the next-generation mobile communication system. Also, orthogonal frequency division multiplexing (OFDM) may be used as a radio access technology, and beamforming technology may be used in addition.

Further, an adaptive modulation and coding (AMC) scheme determining a modulation scheme and channel coding rate to match the channel state of the UE may be applied in the NR gNB. The NR CN 3-05 may perform functions such as mobility support, bearer configuration, and quality of service (QoS) configuration. The NR CN 3-05 is an entity taking charge of not only mobility management but also various control functions for the UE, and may be connected to a plurality of base stations. In addition, the next-generation mobile communication system may interwork with the existing LTE system, and the NR CN may be connected to the MME 3-25 through a network interface. The MME may be connected to an eNB 3-30 being an existing base station.

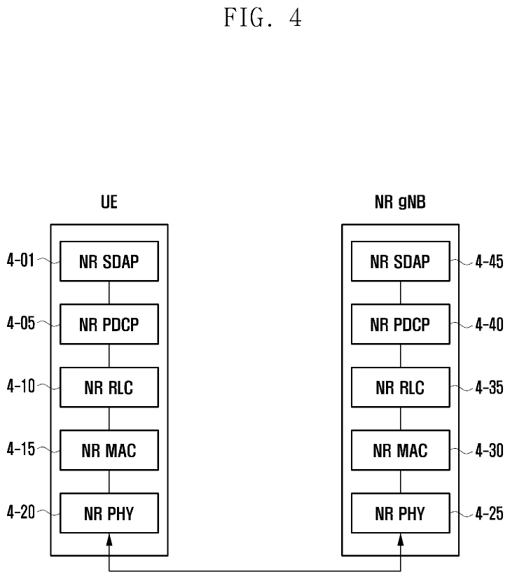

FIG. 4 is a diagram illustrating the structure of radio protocols in a next-generation mobile communication system according to an embodiment of the disclosure.

With reference to FIG. 4, in a UE or an NR gNB, the radio protocols of the next-generation mobile communication system are composed of NR service data adaptation protocol (SDAP) 4-01 or 4-45, NR PDCP 4-05 or 4-40, NR RLC 4-10 or 4-35, NR MAC 4-15 or 4-30, and NR PHY 4-20 or 4-25. It is not limited to the above example, and fewer or more layers than the above example may be included.

According to an embodiment, the main functions of the NR SDAP 4-01 or 4-45 may include some of the following functions in a non-limiting manner.
User data transfer function (transfer of user plane data)
Mapping function between QoS flows and data bearers for uplink and downlink (mapping between a QoS flow and a DRB for both DL and UL)
QoS flow ID marking function for uplink and downlink (marking QoS flow ID in both DL packets and UL packets)
Function of mapping reflective QoS flow to data bearer for uplink SDAP PDUs (reflective QoS flow to DRB mapping for the UL SDAP PDUs) With respect to the SDAP entity, the UE may be configured with, through a radio resource control (RRC) message, whether to use a header of the SDAP entity or whether to use a function of the SDAP entity for each PDCP entity, bearer, or logical channel. If a SDAP header is configured, the SDAP entity may use a NAS (non-access stratum) reflective QoS 1-bit indication and AS (access stratum) reflective QoS 1-bit indication of the SDAP header to instruct the UE to update or reconfigure the mapping information between QoS flows and data bearers for the uplink and downlink. In some embodiments, the SDAP header may include QoS flow ID information indicating the QoS. In some embodiments, the QoS information may be used as data processing priority and scheduling information for supporting smooth services.

According to an embodiment, the main function of the NR PDCP 4-05 or 4-40 may include some of the following functions in a non-limiting manner.
Header compression and decompression function (header compression and decompression: ROHC only)
   User data transfer function (transfer of user data)
In-sequence delivery function (in-sequence delivery of upper layer PDUs)
Out-of-sequence delivery function (out-of-sequence delivery of upper layer PDUs)
Reordering function (PDCP PDU reordering for reception)
Duplicate detection function (duplicate detection of lower layer SDUs)
Retransmission function (retransmission of PDCP SDUs)
Cipher and decipher function (ciphering and deciphering)
Timer-based SDU discard function (timer-based SDU discard in uplink)

In the above description, the reordering function of the NR PDCP entity may mean reordering of PDCP PDUs received from a lower layer in order based on the PDCP sequence number (SN). The reordering function of the NR PDCP entity may include delivering data to an upper layer in reordered sequence, directly delivering data without considering the order, recording lost PDCP PDUs through reordering, reporting the status of lost PDCP PDUs to the transmitting side, or requesting retransmission of the lost PDCP PDUs.

According to some embodiments, the main function of the NR RLC 4-10 or 4-35 may include some of the following functions in a non-limiting manner.
Data transfer function (transfer of upper layer PDUs)
In-sequence delivery function (in-sequence delivery of upper layer PDUs)
Out-of-sequence delivery function (out-of-sequence delivery of upper layer PDUs)
ARQ function (error correction through ARQ)
Concatenation, segmentation and reassembly function (concatenation, segmentation and reassembly of RLC SDUs)
Re-segmentation function (re-segmentation of RLC data PDUs)
Reordering function (reordering of RLC data PDUs)
Duplicate detection function (duplicate detection)
Error detection function (protocol error detection)
   RLC SDU discard function (RLC SDU discard)
RLC re-establishment function (RLC re-establishment)

In the above description, in-sequence delivery of the NR RLC entity may mean in-sequence delivery of RLC SDUs received from a lower layer to an upper layer. In-sequence delivery of the NR RLC entity may include reassembly and delivery of RLC SDUs when several RLC SDUs belonging to one original RLC SDU are received after segmentation.

In-sequence delivery of the NR RLC entity may include reordering of received RLC PDUs based on the RLC sequence number (SN) or the PDCP SN, recording lost RLC PDUs through reordering, reporting the status of the lost RLC PDUs to the transmitting side, and requesting retransmission of the lost RLC PDUs.

If there is a lost RLC SDU, in-sequence delivery of the NR RLC entity may include in-sequence delivery of only RLC SDUs before the lost RLC SDU to an upper layer. Although there is a lost RLC SDU, if a specified timer has expired, in-sequence delivery of the NR RLC entity may include in-sequence delivery of all the RLC SDUs received before the starting of the timer to an upper layer.

Although there is a lost RLC SDU, if a specified timer has expired, in-sequence delivery of the NR RLC entity may include in-sequence delivery of all the RLC SDUs received up to now to an upper layer.

The NR RLC entity may process RLC PDUs in the order of reception regardless of the order of the sequence number, and transfer them to the NR PDCP entity in an out-of-sequence delivery manner.

In case of receiving a segment, the NR RLC entity may reconstruct one whole RLC PDU from segments stored in the buffer or received later, and transfer it to the NR PDCP entity.

The NR RLC layer may not include a concatenation function, which may be performed by the NR MAC layer or may be replaced with a multiplexing function of the NR MAC layer.

In the above description, out-of-sequence delivery of the NR RLC entity may mean a function of transferring RLC SDUs received from a lower layer directly to a higher layer regardless of their order. If several RLC SDUs belonging to one original RLC SDU are received after segmentation, out-of-sequence delivery of the NR RLC entity may include reassembly and delivery of the RLC SDUs. Out-of-sequence delivery of the NR RLC entity may include storing the RLC SNs or PDCP SNs of received RLC PDUs and ordering them to record lost RLC PDUs.

According to some embodiments, the NR MAC 4-15 or 4-30 may be connected to several NR RLC entities configured in one UE, and the main function of the NR MAC may include some of the following functions in a non-limiting manner.
Mapping function (mapping between logical channels and transport channels)
Multiplexing and demultiplexing function (multiplexing/demultiplexing of MAC SDUs)
Scheduling information reporting function (scheduling information reporting)
HARQ function (error correction through HARQ)
Priority handling function between logical channels (priority handling between logical channels of one UE)
Priority handling function between UEs (priority handling between UEs by means of dynamic scheduling)
MBMS service identification function (MBMS service identification)
Transport format selection function (transport format selection)
Padding function (padding)

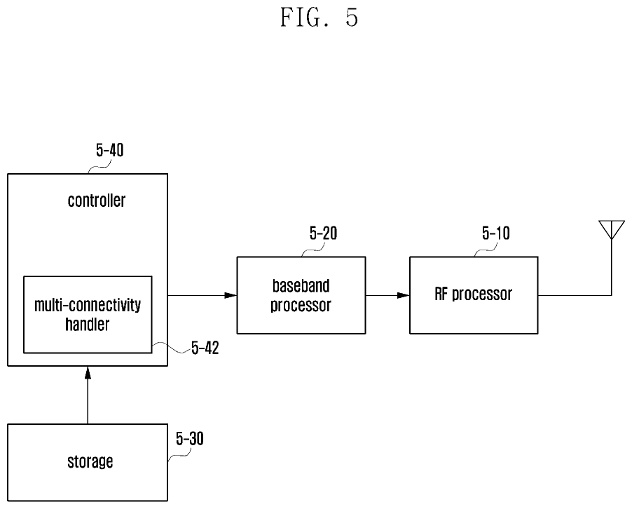

The NR PHY 4-20 or 4-25 may compose OFDM symbols from higher layer data through channel coding and modulation and transmit them through a radio channel, or may demodulate and channel-decode OFDM symbols received through a radio channel and forward the result to a higher layer. However, it is not limited to the above example. FIG. 5 is a block diagram showing the internal structure of a user equipment according to an embodiment of the disclosure.

With reference to FIG. 5, the UE may include a radio frequency (RF) processor 5-10, a baseband processor 5-20, a storage 5-30, and a controller 5-40. Additionally, the controller 5-40 may include a multi-connectivity handler 5-42. However, it is not limited to the above illustration, and the UE may include fewer or more components than those shown in FIG. 5.

The RF processor 5-10 may perform a function for transmitting and receiving a signal through a radio channel, such as signal band conversion and amplification. That is, the RF processor 5-10 may perform up-conversion of a baseband signal provided from the baseband processor 5-20 into an RF-band signal and transmit it through an antenna, and may perform down-conversion of an RF-band signal received through an antenna into a baseband signal. For example, the RF processor 5-10 may include a transmission filter, a reception filter, an amplifier, a mixer, an oscillator, a digital-to-analog converter (DAC), and an analog-to-digital converter (ADC) in a non-limiting manner. Although only one antenna is illustrated in FIG. 5, the UE may be provided with a plurality of antennas. Also, the RF processor 5-10 may include a plurality of RF chains. Further, the RF processor 5-10 may perform beamforming. For beamforming, the RF processor 5-10 may adjust phases and magnitudes of individual signals transmitted and received through the plural antennas or antenna elements. Further, the RF processor 5-10 may perform multiple-input and multiple-output (MIMO), and may receive several layers during MIMO operation.

The baseband processor 5-20 performs conversion between a baseband signal and a bit stream in accordance with the physical layer specification of the system. For example, during data transmission, the baseband processor 5-20 generates complex symbols by encoding and modulating a transmission bit stream. Further, during data reception, the baseband processor 5-20 may reconstruct a reception bit stream by demodulating and decoding a baseband signal provided from the RF processor 5-10. For example, in the case of utilizing orthogonal frequency division multiplexing (OFDM), for data transmission, the baseband processor 5-20 generates complex symbols by encoding and modulating a transmission bit stream, maps the complex symbols to subcarriers, and composes OFDM symbols through inverse fast Fourier transform (IFFT) operation and cyclic prefix (CP) insertion. Further, for data reception, the baseband processor 5-20 may divide a baseband signal provided from the RF processor 5-10 in units of OFDM symbols, restore the signals mapped to subcarriers through fast Fourier transform (FFT) operation, and reconstruct the reception bit stream through demodulation and decoding.

The baseband processor 5-20 and the RF processor 5-10 transmit and receive signals as described above. Hence, the baseband processor 5-20 and the RF processor 5-10 may be called a transmitter, a receiver, a transceiver, or a communication unit. Further, to support different radio access technologies, at least one of the baseband processor 5-20 or the RF processor 5-10 may include a plurality of communication modules. In addition, to process signals of different frequency bands, at least one of the baseband processor 5-20 or the RF processor 5-10 may include different communication modules. For example, the different radio access technologies may include a wireless LAN (e.g., IEEE 802.11), a cellular network (e.g., LTE), and the like. In addition, the different frequency bands may include a super high frequency (SHF) band (e.g., 2.NRHz, NRhz) and a millimeter wave (mmWave) band (e.g., 60 GHz). The UE may transmit and receive signals to and from a base station by using the baseband processor 5-20 and the RF processor 5-10, and the signal may include control information and data.

The storage 5-30 stores data such as basic programs, application programs, and configuration information for the operation of the UE. In particular, the storage 5-30 may store information about a second access node that performs wireless communication using a second radio access technology. The storage 5-30 provides stored data in response to a request from the controller 5-40. The storage 5-30 may be composed of a storage medium such as ROM, RAM, hard disk, CD-ROM, or DVD, or a combination of storage media. Further, the storage 5-30 may be composed of a plurality of memories.

The controller 5-40 controls the overall operation of the UE. For example, the controller 5-40 transmits and receives signals through the baseband processor 5-20 and the RF processor 5-10. Further, the controller 5-40 writes or reads data to or from the storage 5-40. To this end, the controller 5-40 may include at least one processor. For example, the controller 5-40 may include a communication processor (CP) for controlling communication and an application processor (AP) for controlling higher layers such as application programs. Additionally, at least one component within the UE may be implemented with one chip. According to an embodiment of the disclosure, the controller 5-40 may control individual components of the UE to transmit and receive control information in the IAB system. A method of operating the UE according to an embodiment of the disclosure will be described in more detail below.

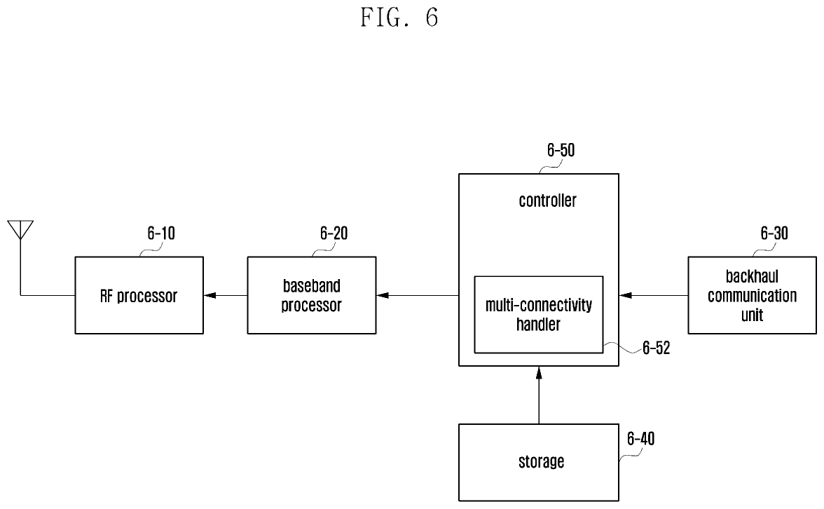

FIG. 6 is a block diagram showing the configuration of an NR base station according to an embodiment of the disclosure.

With reference to FIG. 6, the base station may include an RF processor 6-10, a baseband processor 6-20, a backhaul communication unit 6-30, a storage 6-40, and a controller 6-50. Additionally, the controller 6-50 may include a multi-connectivity handler 6-52. However, it is not limited to the above illustration, and the base station may include fewer or more components than those shown in FIG. 6.

The RF processor 6-10 may perform a function for transmitting and receiving a signal through a radio channel, such as signal band conversion and amplification. That is, the RF processor 6-10 performs up-conversion of a baseband signal provided from the baseband processor 6-20 into an RF-band signal and transmits the converted signal through an antenna, and performs down-conversion of an RF-band signal received through an antenna into a baseband signal. For example, the RF processor 6-10 may include a transmission filter, a reception filter, an amplifier, a mixer, an oscillator, a DAC, and an ADC. Although only one antenna is illustrated in FIG. 6, the RF processor 6-10 may be provided with a plurality of antennas. Additionally, the RF processor 6-10 may include a plurality of RF chains. Further, the RF processor 6-10 may perform beamforming. For beamforming, the RF processor 6-10 may adjust phases and amplitudes of individual signals transmitted and received through plural antennas or antenna elements. The RF processor 6-10 may perform downlink MIMO operation by transmitting one or more layers.

The baseband processor 6-20 may perform conversion between a baseband signal and a bit stream in accordance with the physical layer specification of a first radio access technology. For example, for data transmission, the baseband processor 6-20 may generate complex symbols by encoding and modulating a transmission bit stream. Further, for data reception, the baseband processor 6-20 may reconstruct a reception bit stream by demodulating and decoding a baseband signal provided from the RF processor 6-10. For example, in the case of utilizing OFDM, for data transmission, the baseband processor 6-20 generates complex symbols by encoding and modulating a transmission bit stream, maps the complex symbols to subcarriers, and composes OFDM symbols through IFFT operation and CP insertion. Further, for data reception, the baseband processor 6-20 divides a baseband signal provided from the RF processor 6-10 in units of OFDM symbols, restores the signals mapped to subcarriers through FFT operation, and reconstructs the reception bit stream through demodulation and decoding. The baseband processor 6-20 and the RF processor 6-10 transmit and receive signals as described above. Hence, the baseband processor 6-20 and the RF processor 6-10 may be called a transmitter, a receiver, a transceiver, a communication unit, or a wireless communication unit. The base station may transmit and receive signals to and from a UE by using the baseband processor 6-20 and the RF processor 6-10, and the signal may include control information and data.

The backhaul communication unit 6-30 provides an interface for communication with other nodes in the network. That is, the backhaul communication unit 6-30 may convert a bit stream, which is to be transmitted from the primary base station to another node, for example, a secondary base station or the core network, into a physical signal, and may convert a physical signal received from another node into a bit stream. The backhaul communication unit 6-30 may be included in a communication unit.

The storage 6-40 stores data such as basic programs, application programs, and configuration information for the operation of the base station. The storage 6-40 may store information on a bearer allocated to a connected UE and measurement results reported from the connected UE. Further, the storage 6-40 may store information used as a criterion for determining whether to provide or suspend multi-connectivity to the UE. In addition, the storage 6-40 provides stored data in response to a request from the controller 6-50. The storage 6-40 may be composed of a storage medium such as ROM, RAM, hard disk, CD-ROM, or DVD, or a combination of storage media. Further, the storage 6-40 may be composed of a plurality of memories. According to some embodiments, the storage 6-40 may store a program for executing a buffer status report method according to the disclosure.

The controller 6-50 controls the overall operation of the base station. For example, the controller 6-50 transmits and receives signals through the baseband processor 6-20 and the RF processor 6-10 or through the backhaul communication unit 6-30. In addition, the controller 6-50 writes or reads data to or from the storage 6-40. To this end, the controller 6-50 may include at least one processor. Further, at least one component of the base station may be implemented with one chip.

According to an embodiment of the disclosure, the controller 6-50 may control individual components of the base station to transmit and receive control information in the IAB system according to an embodiment of the disclosure. The operating method of the base station according to an embodiment of the disclosure will be described in more detail below.

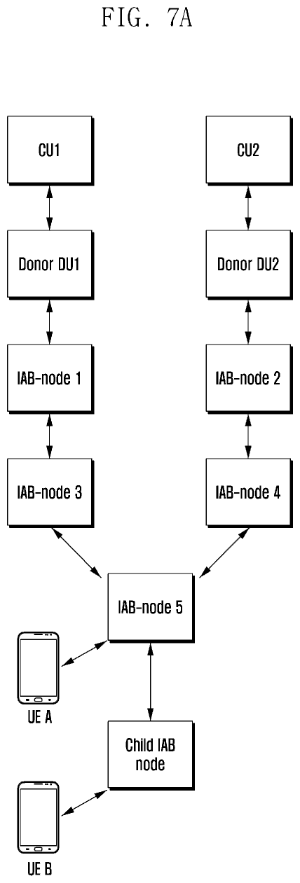

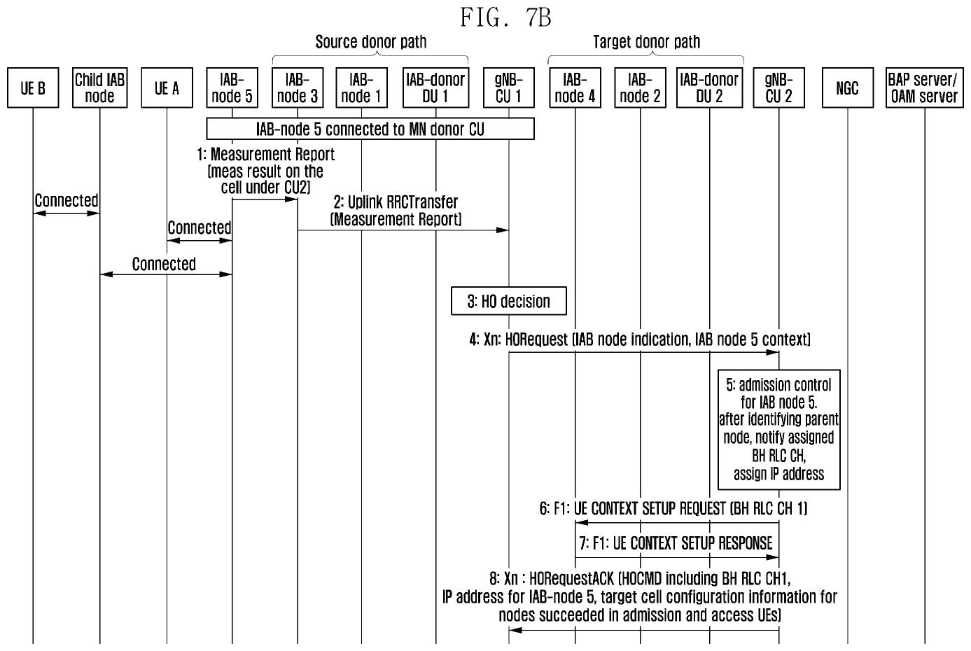

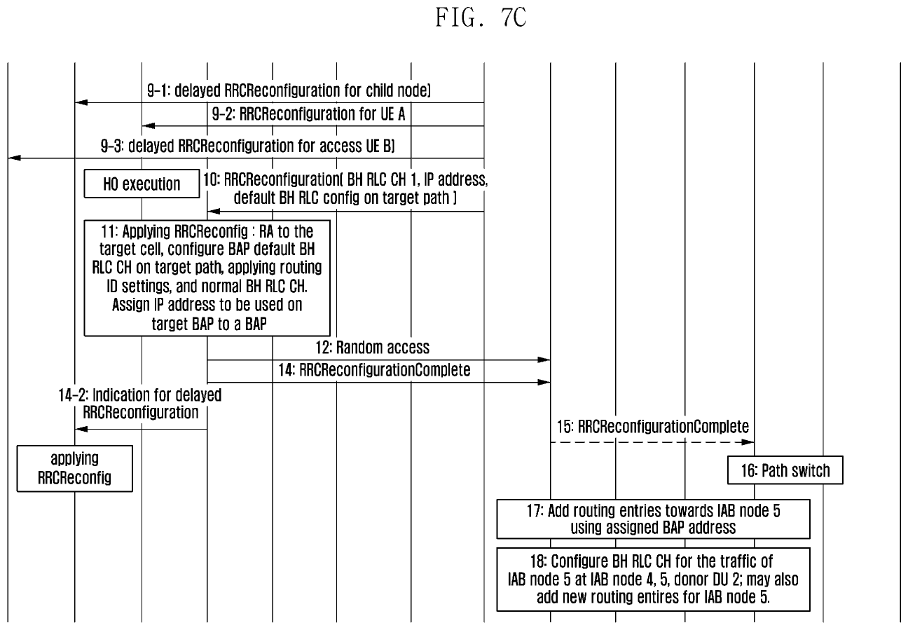

FIG. 7A illustrates a network structure architecture according to an embodiment of the disclosure. The network structure of FIG. 7A illustrates, as network nodes, central unit (CU) 1, CU2, donor distributed unit (DU) 1, donor DU2, integrated access and backhaul (IAB) node 1, IAB node 2, IAB node 3, IAB node 4, IAB node 5, child IAB node, UE A, and UE B. However, this is only an illustration, and embodiments according to the disclosure may be formed in various ways by including at least one CU, at least one DU, at least one IAB node, and at least one UE.

FIG. 7B illustrates signal flows when admission control is performed collectively in migration according to an embodiment of the disclosure. FIG. 7C illustrates signal flows when admission control is performed collectively in migration according to an embodiment of the disclosure. After operations in FIG. 7B are performed, operations in FIG. 7C may be performed.

Referring to FIGS. 7B and 7C, the donor node may determine to migrate an IAB node that maintains a connection with the source donor node. In this case, the donor node becomes the source node, and the donor node to be a migration target may be referred to as a target donor node.

Step 4: after determining to migrate a specific IAB node, the source donor node may transmit a handover request message to the target node. This message may include the following information:

In addition to existing legacy HORequest information, IAB node indication and configuration information of IAB node 5 (migrating node) at the source may be included. In particular, a BAP address among BAP config (backhaul adaptation protocol configuration) may be included. Assuming that the BAP address allocated by the source CU is also reused in the target CU, the BAP address and information of the migrating IAB node may be included in this message. Additionally, based on the topology of the migrating IAB node, information regarding the number of hops from the migrating node to each descendant node, parent-child relationship of each descendant node, UE ID and radio bearer of the access UE for each node, UE aggregate maximum bit rate (AMBR) and radio resource control (RRC) configuration of each node and access UE in the serving cell may be included. Through this information, the target donor node may determine the amount of data required for each descendant node and its access UE to perform admission.

Step 5: admission control can be performed for the migrating node, descendant nodes, and their access UEs indicated in the message at step 4. Based on the CGI (cell global identity) information included in the message at step 4, the target CU may identify the target parent node, allocate a BH RLC CH (backhaul radio link control channel) to be used by the migrating node after connection (e.g., BH RLC CH 1), and assign an IP address or TNL (transport network layer) address based on the donor DU2 that is associated with the migrating node after connection.

Step 6: the parent node (IAB node 4) may be configured with the BH RLC CH allocated at step 5.

Step 7: configuration information at the target cell based on the DU and cell information of the target parent node that will accommodate the migrating node is returned to the target CU.

Step 8: admission control is continuously performed for the migrating node, descendant nodes, and their access UEs indicated in the message at step 4. Also, for an IAB node having succeeded in admission control, delayed RRCReconfiguration information is created for the descendant nodes of the IAB node. Further, delayed RRCReconfiguration is also created for each UE having succeeded in admission among access UEs of each node. This means configuration information at the target cell.

A handoverRequestAck message, which includes the ID of the node having succeeded in admission, the ID of the access UE having succeeded in admission, and configuration information of the node and UE at the target cell, is delivered to the source donor node.

Step 9: the source donor node may issue a mobility command to the access UE and descendant node that have failed in admission. For example, a command such as handover to another IAB node or RRC release may be issued. Further, a delayed RRCReconfiguration message received from the target donor node may be delivered to the node having succeeded in admission and the access UE having succeeded in admission, respectively.

Step 9-1: delayed RRCReconfiguration is deliver to the child node. This message is one created by the target donor node at step 8, and RRCReconfiguration contains an indication of buffering this message upon reception and applying it when receiving a specific message. Additionally, this message may include a migrating node ID, and it is stored until the parent node of this child node delivers a message/signal instructing applying RRCReconfiguration.

Step 9-2: if UE A has failed in admission control, the source donor node may issue a command to handover to another cell. Here, the RRCReconfiguration message may correspond to a handover command.

Step 9-3: the source donor node may deliver delayed RRCReconfiguration to the access UE having succeeded in admission. Delayed RRCReconfiguration allows the UE to store the RRCReconfiguraiton message and apply the stored RRCReconfiguration message when a specific condition is met. This RRCReconfiguration message may correspond to a conditional handover configuration. For a conditional handover configuration, this delayed RRCReconfiguration message is included in a normal RRCReconfiguration message and may be delivered to the UE in association with a measurement ID indicating a condition. For other than conditional handover, the delayed RRCReconfiguration is a normal RRCReconfiguration message including an indication, so that the UE receiving this may store it and apply it when a condition is met.

The condition to be satisfied for the above application may be as follows:
The per-cell measurement signal strength of a specific target cell is greater than the current source cell by a threshold value, and the absolute signal strength of the corresponding target cell is greater than or equal to a threshold value. In this case, the specific target cell may be a handover target cell that has already been included in RRCReconfiguration by the target donor node in consideration of the DU configuration of the parent node of the child node.
As another condition, the NR CGI value of the source cell is changed and broadcast.

That is, when a change in NR CGI broadcast through SIB is detected, handover is performed to the target cell specified in RRCReconfiguration (that is, the PCI on the frequency specified in the reconfigurationWithSync field of delayed RRCReconfiguration is the target cell).
The serving cell transmits a separate indication signal/message. This may be included in PDCCH or DCI of the Phy layer, or may be transmitted in MAC CE. Alternatively, a separate RRC message may be used. The access UE that receives this message/signal may apply the stored RRCReconfiguration message.

Step 10: IAB node 5 applies received RRCReconfiguration. This may provide a BH RLC CH to be used with the parent node in the target path, an IP address to be used in the BAP, a default BH RLC CH and routing ID to be used for UL traffic until RA (random access) is successful and the BAP is additionally configured through F1.

Step 11: applying RRCReconfig: perform a random access procedure to the target cell (RA to the target cell). Apply default BH RLC CH, BAP routing ID settings, and configure normal BH RLC CH on the target path. Assign an IP address to be used on the target path to the BAP.

Step 12: a random access preamble may be transmitted to the cell of the target parent IAB node and an RAR may be received. Then, a RRCReconfigurationComplete message may be transmitted to the target cell.

If RRCReconfiguration of the parent node is successfully completed, the corresponding node may transmit an indication to its child node to instruct application of the delayed RRCReconfiguration message. In this case, the child node at step 9-1 has already stored the delayed RRCReconfiguration message, and if migration of IAB node 5 is completed successfully, the migrating node may deliver an indication at step 14-2. The node having received this indication applies RRCReconfiguration.

Step 15: the IAB node on the target path having received RRCReconfgiruation Complete, indicating the success of the HO procedure, from the migrating IAB node forwards it to the target donor CU.

Step 16: the target donor CU having received this may request the AMF to allow the DL data path of the migrating IAB node, child node, and access UEs served by them to pass through the new donor CU.

Step 17: add an entry for transmission of DL traffic of IAB node 5 to the routing entries of IAB nodes on the path from the parent node of the migrating IAB node to the donor DU. Here, the BAP address from the target donor for the migrating IAB node received at step 8 is used.

Step 18: among the routing information of IAB nodes on the path from the parent node of the migrating IAB node to the donor DU, BH RLC CH is additionally configured for the traffic of IAB node 5. Further, a routing entry for transmission of UL traffic of IAB node 5 may be added.

In the embodiments of the disclosure described above, the elements included in the disclosure are expressed in a singular or plural form according to the presented specific embodiment. However, the singular or plural expression is appropriately selected for ease of description according to the presented situation, and the disclosure is not limited by a single element or plural elements. Those elements described in a plural form may be configured as a single element, and those elements described in a singular form may be configured as plural elements.

Meanwhile, specific embodiments have been described in the detailed description of the present disclosure, but various modifications are possible without departing from the scope of the disclosure. Therefore, the scope of the disclosure should not be limited to those described embodiments, but should be determined by not only the appended claims but also their equivalents.

1. A method performed by a source base station including a central unit (CU) and a distributed unit (DU) in a wireless communication system supporting integrated access and backhaul (IAB), the method comprising:
transmitting, to a target base station, a handover request message including an indication indicating migration of at least one IAB node; and
receiving, from the target base station, a handover request response message including configuration information according to a result of admission control based on the indication.

2. The method of claim 1, wherein the handover request message includes information related to the IAB node, a BAP address, and information related to a topology of the IAB node.

3. The method of claim 2, wherein admission control is performed based on an amount of data required by individual descendant nodes and their access UEs indicated by the information related to the topology of the IAB node.

4. The method of claim 1, further comprising, based on the received handover request response message, transmitting a mobility command message to a descendant node and its access UE having failed in admission control, and transmitting a delayed RRCReconfiguration message to a descendant node and its access UE having succeeded in admission control.

5. A method performed by a target base station including a central unit (CU) and a distributed unit (DU) in a wireless communication system supporting integrated access and backhaul (IAB), the method comprising:
receiving, from a CU of a source base station, a handover request message including an indication indicating migration of at least one IAB node;
performing admission control based on the handover request message; and
transmitting a handover request response message including configuration information according to a result of admission control.

6. The method of claim 5, wherein performing admission control comprises allocating resources based on an amount of data required by individual descendant nodes and their access UEs for the IAB node included in the handover request message.

7. The method of claim 5, wherein performing admission control comprises:
allocating, by the CU of the target base station, a backhaul radio link control channel (BH RLC CH) to be used by the IAB node after connection; and
assigning a transport network layer (TNL) address based on the DU of the target base station.

8. The method of claim 5, further comprising generating delayed RRCReconfiguration configuration information for descendant nodes and their access UEs that have succeeded in admission control, and wherein the handover request response message includes descendant nodes having succeeded in admission control, IDs of their access UEs, and the delayed RRCReconfiguration configuration information.

9. A source base station including a central unit (CU) and a distributed unit (DU) in a wireless communication system supporting integrated access and backhaul (IAB),
wherein the CU is configured to transmit, to a target base station, a handover request message including an indication indicating migration of at least one IAB node, and receive, from the target base station, a handover request response message including configuration information according to a result of admission control based on the indication.

10. The source base station of claim 9, wherein the handover request message includes information related to the IAB node, a BAP address, and information related to a topology of the IAB node.

11. The source base station of claim 10, wherein admission control is performed based on an amount of data required by individual descendant nodes and their access UEs indicated by the information related to the topology of the IAB node.

12. The source base station of claim 9, wherein based on the received handover request response message, a mobility command message is transmitted to a descendant node and its access UE having failed in admission control, and a delayed RRCReconfiguration message is transmitted to a descendant node and its access UE having succeeded in admission control.

13. A target base station including a central unit (CU) and a distributed unit (DU) in a wireless communication system supporting integrated access and backhaul (IAB),
wherein the CU is configured to receive, from a CU of a source base station, a handover request message including an indication indicating migration of at least one IAB node, perform admission control based on the handover request message, and transmit a handover request response message including configuration information according to a result of admission control.

14. The target base station of claim 13, wherein the CU is configured to allocate resources based on an amount of data required by individual descendant nodes and their access UEs for the IAB node included in the handover request message, allocate a backhaul radio link control channel (BH RLC CH) to be used by the IAB node after connection, and assign a transport network layer (TNL) address based on the DU of the target base station.

15. The target base station of claim 13, wherein the CU is configured to generate delayed RRCReconfiguration configuration information for descendant nodes and their access UEs that have succeeded in admission control, and wherein the handover request response message includes descendant nodes having succeeded in admission control, IDs of their access UEs, and the delayed RRCReconfiguration configuration information.
